(19) United States
(12) Patent Application Publication
(10) Pub. No.: US 2020/0008574 A1
(43) Pub. Date: Jan. 9, 2020

(54) READY-TO-ASSEMBLE FURNITURE KIT, CONSTRUCTION AND METHOD OF ASSEMBLY

(71) Applicant: ADEPTUS IP, LLC, Norfolk, VA (US)

(72) Inventor: William C. White, Norfolk, VA (US)

(21) Appl. No.: 16/447,858

(22) Filed: Jun. 20, 2019

Related U.S. Application Data
(60) Provisional application No. 62/849,480, filed on May 17, 2019.
(60) Provisional application No. 62/687,301, filed on Jun. 20, 2018.

(51) Int. Cl. A47B 88/90; F16B 12/10; A47B 88/417

(52) U.S. Cl. CPC A47B 88/941; F16B 2012/103; A47B 88/417; F16B 12/10

(57) ABSTRACT

A ready-to-assemble furniture kit, construction, and method of assembly. The ready-to-assemble furniture generally comprises a bottom panel having a front edge, a rear edge, and first and second side edges; a first and second side panels mounted parallel to each other, each side panel having an interior surface and an exterior surface defined between a front edge, a rear edge, a top edge and a bottom edge; the interior surface forming at least one longitudinal slot positioned proximate to the bottom edge operably shaped for receipt of the respective bottom panel first and second side edge; a back panel having an interior surface, and first and second side edges; at least one nylon dowel connector connecting each of the rear edges of the first and second side panels with the respective back panel first and second side edges; a front panel having an interior surface, and first and second side edges; and at least one nylon dowel connector connecting each of the front edges of the first and second side panels with the respective front panel first and second side edges; wherein each nylon dowel connector comprises an elongated body having a midsection, opposing sides, and a plurality of longitudinally aligned truncated cone sections extending from the midsection being tapered towards the opposite side of the body.

### CROSS-REFERENCE TO RELATED APPLICATION

This application is based upon and claims the priority filing date of the previously filed, copending U.S. Provisional patent application entitled “READY TO ASSEMBLY (RTA) ROLL CART METHOD AND CONSTRUCTION” filed Jun. 20, 2018, Ser. No. 62/687,301, the entire disclosure of which is hereby incorporated herein by reference and copending U.S. Provisional patent application entitled “READY TO ASSEMBLY (RTA) ROLL CART METHOD AND CONSTRUCTION” filed May 17, 2019, Ser. No. 62/849,480, the entire disclosure of which is hereby incorporated herein by reference.

### FIELD OF THE INVENTION

The present invention relates to the field of ready-to-assemble furniture construction, also known as knock-down, flat pack furniture, or kit furniture.

### BACKGROUND

Ready-to-assemble furniture (RTA), also known as knock-down furniture (KD), flat pack furniture, or kit furniture, is a form of furniture that requires customer assembly. The separate components are packed in cartons which also contain assembly instructions. The furniture is generally simple to assemble with basic tools such as hammer and/or screwdriver, which are also sometimes included.

RTA furniture is popular with consumers who wish to save money by assembling the product themselves and collecting the furniture from the store, saving delivery costs.

Producers and merchants benefit from selling RTA furniture because ready-assembled furniture tends to be bulky and thus more expensive to store and to deliver. Because the work of assembly is done by the consumer instead of in the factory, it is also cheaper to produce.

As an example, certain RTA furniture may include a roll cart type which is defined by a plurality of drawers positioned within a rectangular frame. The roll cart having a set of rotatable wheels attached to the bottom which allows the cart to be moved or roll upon a surface. Current RTA roll cart construction does benefit from the aforementioned advantages for both the manufacturer and the consumer—by saving money. However, typical assembly time can be somewhat difficult and time-consuming, particularly for some consumers who have little experience utilizing nails, screws, and requisite tools such as screwdrivers and hammers. Often times, assembly time of traditional RTA roll carts can be 1-3 hours for someone skilled in assembly and much longer for someone who is not familiar with RTA type furniture.

Applicant has identified a number of deficiencies and problems associated with the manufacture, design, and use of conventional RTA furniture and RTA roll carts. Through applied research, effort, ingenuity, and innovation, Applicant has solved many of the identified problems regarding assembly time and construction by developing a unique version embodied by the present invention, which is described in detail below.

### SUMMARY

The present invention addresses current needs and achieves other advantages by providing a knockdown roll cart that is lightweight, easy to assemble, and inexpensive to manufacture, ship and sell. Thereby providing the end consumer with a superior product at a competitive cost. The invention does not require the use of a screwdriver—which reduces assembly time to approximately 30 minutes as opposed to 90 minutes.

In a version of the application, a ready-to-assembly drawer assembly construction generally comprises a bottom panel having a front edge, a rear edge, and first and second side edges; a first and second side panels mounted parallel to each other, each side panel having an interior surface and an exterior surface defined between a front edge, a rear edge, a top edge and a bottom edge; the interior surface forming at least one longitudinal slot positioned proximate to the bottom edge operably shaped for receipt of the respective bottom panel first and second side edge; a back panel having an interior surface, and first and second side edges; at least one nylon dowel connector connecting each of the rear edges of the first and second side panels with the respective back panel first and second side edges; a front panel having an interior surface, and first and second side edges; and at least one nylon dowel connector connecting each of the front edges of the first and second side panels with the respective front panel first and second side edges; wherein each nylon dowel connector comprises an elongated body having a midsection, opposing sides, and a plurality of longitudinally aligned truncated cone sections extending from the midsection being tapered towards the opposite side of the body.

In certain versions of the application, the back panel first and second side edges are connected by at least two vertically aligned dowel connectors to the first and second side panel interior surfaces near the respective first and second side rear edges.

In other versions, each side panel front edge is connected by at least two vertically aligned dowel connectors to the front panel interior surface near each respective front panel first and second side edges.

In some versions of the ready-to-assemble construction, each of the first and second side panels interior surfaces further form a second longitudinal slot positioned proximate to the top edge operably shaped for receipt of the respective bottom panel side edge, thereby permitting the first and second side panels to be interchangeable.

In yet another version of the application, the back panel interior surface further forms a second longitudinal slot positioned proximate to the back panel top edge operably shaped for receipt of the respective bottom panel rear edge, thereby permitting the first and second side panels to be interchangeable.

In certain versions of the application, the ready-to-assembly drawer is in the form of a kit, generally the kit comprises in combination: a bottom panel having a front edge, a rear edge, and first and second side edges; a first and second side panels, each side panel having an interior surface and an exterior surface defined between a front edge, a rear edge, a top edge and a bottom edge; the interior surface forming at least one longitudinal slot positioned proximate to the bottom edge; a back panel having an interior surface, first and second side edges; a front panel having an interior surface, and first and second side edges; a plurality of nylon dowel connectors for connecting the front panel, back panel, and first and second side panels, each nylon dowel connector comprises an elongated body having a midsection, opposing sides, and a plurality of longitudinally aligned truncated cone sections extending from the midsection being tapered towards the opposite side of the body.

In certain versions of the kit, the back panel first and second side edges define at least two vertically aligned dowel holes for receipt of one or more nylon dowel connectors and the first and second side panel interior surfaces near the respective rear edges define at least two reciprocal vertically aligned dowel holes for receipt of one or more nylon dowel connectors.

In other versions of the kit, each side panel front edge forms at least two vertically aligned dowel holes for receipt of one more nylon dowel connectors and the front panel interior surface near each respective first and second side edges define at least two reciprocal vertically aligned dowel holes for receipt of one more nylon dowel connectors.

The kit may also optionally include the feature of each of the first and second side panels interior surfaces further form a second longitudinal slot positioned proximate to the top edge, thereby permitting the first and second side panels to be interchangeable.

In other forms of the kit, the back panel interior surface may further form a second longitudinal slot positioned proximate to the back panel top edge operably shaped for receipt of the respective bottom panel rear edge, thereby permitting the first and second side panels to be interchangeable.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The test tube removal device and system may, however, be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF THE DRAWINGS

These and other features, aspects, and advantages of the present invention will become better understood with regard to the following description and accompanying figures where:

FIG. 1 is an assembled left-side perspective view of a version of the RTA furniture having a plurality of assembled drawers.

FIG. 2 is an assembled view of a version of an RTA drawer assembly;

FIG. 3 is a perspective view of a version of the dowel connector having truncated cone sections;

FIG. 4 is a perspective view of a second version of the dowel connector having truncated cone sections and a longitudinal slot;

FIG. 5 is a cross-section view of an example connection between furniture panels utilizing a dowel connector having truncated cone sections;

FIG. 6 is an unassembled view of a version of the RTA drawer assembly shown assembled in FIG. 2;

FIG. 7 is an unassembled up-close view of a side panel, back panel and bottom panel of the drawer assembly as shown in FIG. 2;

FIG. 8 is an unassembled view of the first and second side panel, back panel, front panel, and bottom panel of the drawer assembly as shown in FIG. 2;

FIG. 9 is an unassembled view of the front panel, bottom panel and partial first and second side panels of the drawer assembly as shown in FIG. 2;

FIG. 10 is a partially assembled perspective view of the drawer assembly shown in FIG. 2 showing the back panel, the first and second side panel;

FIG. 11 is a partially assembled front perspective view of the drawer assembly shown in FIG. 2 showing assembly of the back panel, the first and second side panel, and the bottom panel;

FIG. 12 is an assembled front perspective view of the drawer assembly shown in FIG. 2;

FIG. 13 is an assembled right-side perspective view of a version of the RTA furniture or roll cart having assembled drawers;

FIG. 14 is a front perspective view of assembled forward and rear castor support assemblies of the version of the RTA furniture of FIG. 1;

FIG. 15 is a partially assembled front perspective view of the version shown in FIG. 1 showing assembly of the forward and rear castor assemblies with the furniture first side panel;

FIG. 16 is a partially assembled front perspective view of the version shown in FIG. 1 showing assembly of the forward and rear castor assemblies with the furniture first and second side panels;

FIG. 17 is a partially assembled front perspective view of the version shown in FIG. 1 showing assembly of the forward and rear castor assemblies with the furniture first and second side panels, and the furniture back panel;

FIG. 18 is a partially assembled top perspective view of the version shown in FIG. 1 showing assembly of the forward and rear castor assemblies, the furniture first and second side panels, and the furniture rear panel;

FIG. 19 is a bottom view of the furniture top panel of the version shown in FIG. 1;

FIG. 20 is a bottom view of the furniture top panel with dowels connectors of the version shown in FIG. 1;

FIG. 21 is a partial side unassembled view of the top panel apart from the first and second side panel to edges of the version shown in FIG. 1;

FIG. 22 is an assembled front perspective view of the framework assembly of the version shown in FIG. 1 of the RTA furniture.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other versions that depart from these specific details. In other instances, detailed descriptions of well-known devices and methods are omitted so as not to obscure the description of the present invention with unnecessary detail.

Moreover, the description is not to be taken in the limiting sense but is made merely for the purpose illustrating the general principles of the invention, since the scope of the invention is best defined by the appended claims. Various inventive features are described below that can each be used independently of one another or in combination with other features.

Unless otherwise defined, all technical terms used herein have the same meaning as commonly understood by one of ordinary skill in the art to which the invention belongs. As used in the specification and the appended claims, the singular forms “a,” “an,” and “the” include plural references unless the context clearly dictates otherwise. Any reference to “or” herein is intended to encompass “and/or” unless otherwise stated.

With reference now to the drawings, a new ready-to-assemble furniture unit 10 embodying the principles and concepts of the present invention is shown. Generally, the ready-to-assemble furniture unit 10 is provided to the end user as a kit to be assembled by the user. Thus, the RTA unit 10 can be either assembled by the manufacturer before shipping or by the end consumer in order to reduce the overall cost of the RTA unit. Put simply, the RTA unit 10 addresses current needs and achieves other advantages by providing a ready-to-assemble furniture unit that is lightweight, easy to assemble, and inexpensive to manufacture, ship and sell. Thereby providing the end consumer with a superior product at a competitive cost. Moreover, the invention does not require the use of a screwdriver—which reduces assembly time to approximately 30 minutes as opposed to 90 minutes.

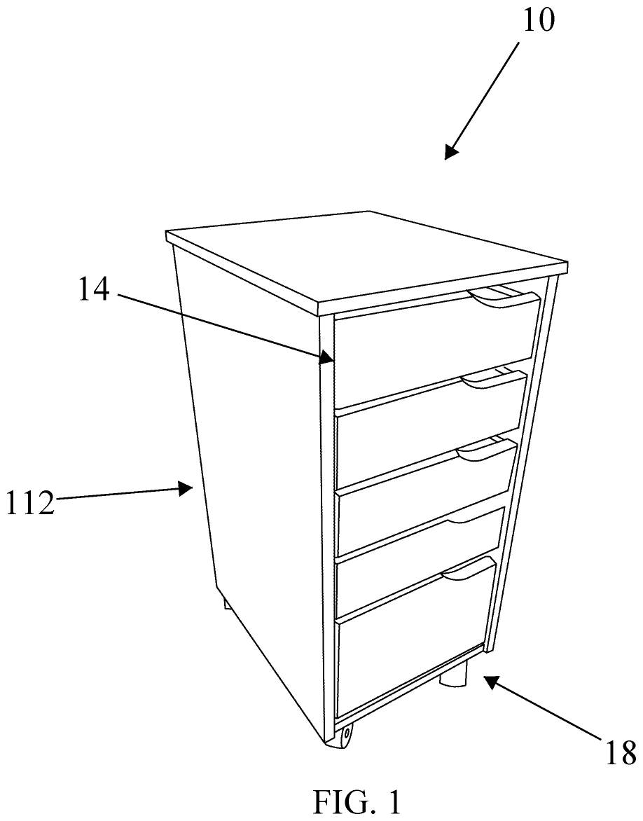

Referring to FIG. 1, is a perspective from view of a ready-to-assemble furniture unit further in the form of a roll cart 10. The RTA unit 10 generally comprises a framework assembly 112 operably configured to support a plurality of vertically stacked drawer assemblies 14 therein. Specifically, the drawer assemblies 14 are configured to each independently translate along a set of drawer runners within the framework assembly 112. In the version, the RTA unit 10 and framework assembly 112 is supported by a forward and rear castor support assemblies 114 having castors 126 designed to allow the cart 10 to move and roll across a flat surface.

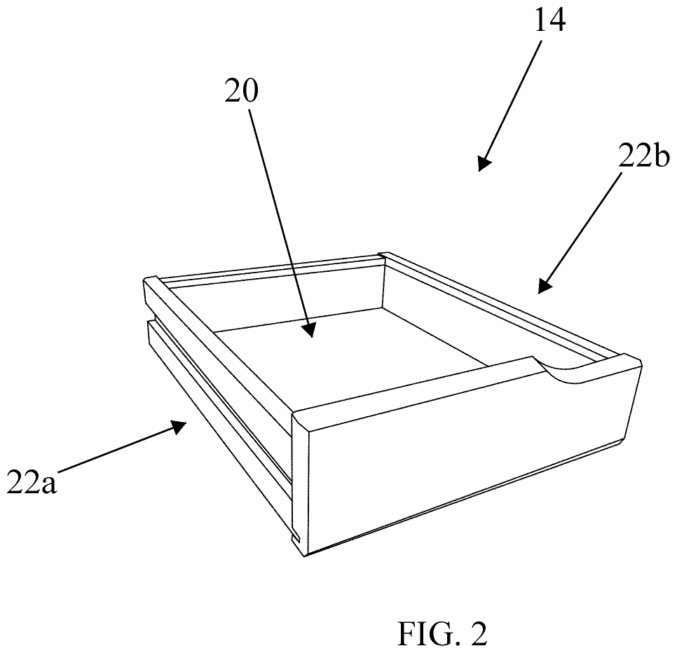

Now with reference to FIG. 2-FIG. 12, the plurality of drawer assemblies 14 easily assemble to provide a rectangular box structure having right angle edges. Generally, each drawer assembly 14 comprises a drawer bottom panel 20, drawer first and second side panels 22a, 22b, drawer back panel 24, and a drawer front panel 26.

As best shown in FIG. 6, the drawer bottom panel 20 generally includes a front edge 28, a rear edge 30, and first and second side edges 32, 34 defining a thin supportive plate defining a rectangular perimeter.

With reference to FIG. 6-FIG. 10, the first and second side panels 22a, 22b are generally a rectangular block configuration horizontally mounted in parallel—each having a front edge 36, a rear edge 38, a top edge 40, a bottom edge 42 defining an elongated rectangle having an interior surface 44 and an exterior surface 46.

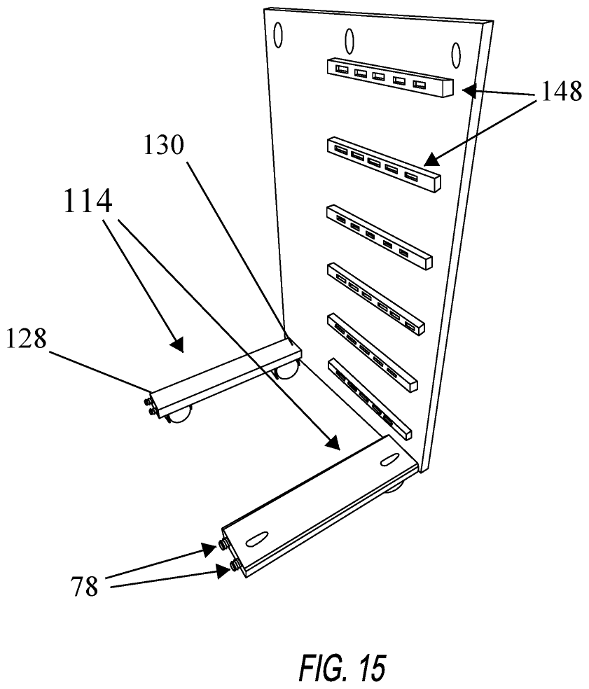

Each of the first and second panels 22a, 22b interior surfaces 44 has a longitudinal slot 48 positioned proximate to the bottom edge 42 for receipt of the respective drawer bottom panel 20 first and second side edges 32, 34. In some versions, the exterior surface 46 is configured to have a longitudinal groove 50 which is operably configured to receive the respective framework assembly 12 drawer runners 148 (FIG. 15).

Referring to FIG. 6—FIG. 8, the drawer back panel 24 is generally a rectangular block configuration having and interior surface 52 and an exterior surface 54 (not shown) defined between reciprocal first and second side edges 56, 58, top edge 60 and a bottom edge 62. Further, the drawer back panel 24 includes a first longitudinal slot 25 for receipt of the drawer bottom panel 20 rear edge 30 during assembly. The drawer back panel 24 is generally designed such that is can be inverted or interchangeable with other drawer back panels thereby mitigating the prospect to improperly assemble.

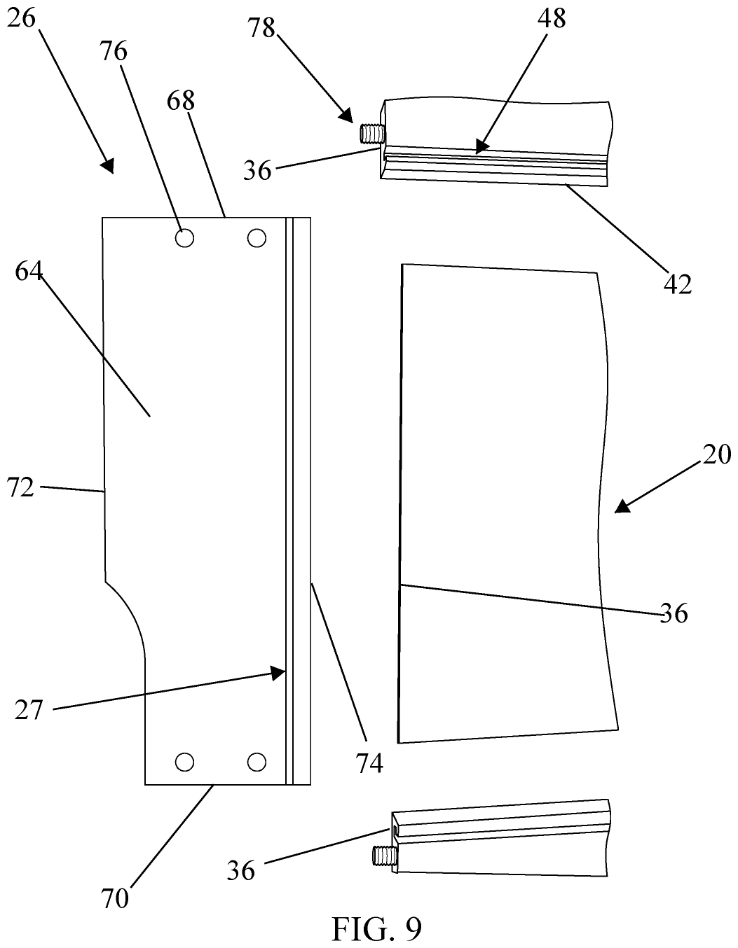

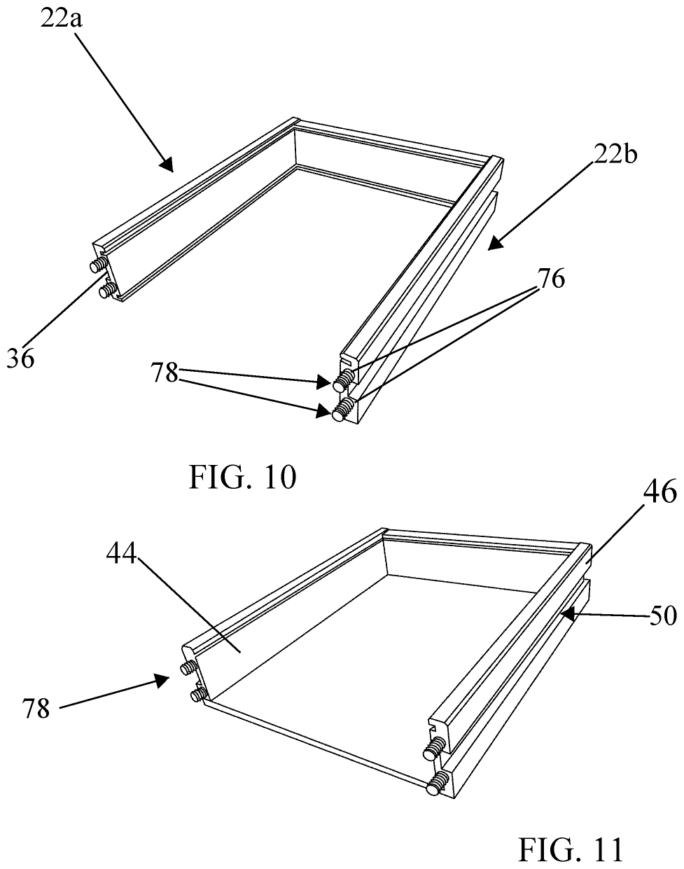

The drawer front panel 26 best illustrated in FIG. 9 and FIG. 10, generally comprises an interior surface 64 and exterior surface 66 defined between a first and second side edges 68, 70, top edge 72, and a bottom edge 74 forming generally a rectangular configuration. Further, the drawer front panel 26 includes a first longitudinal slot 27 for receipt of the drawer bottom panel 20 front edge 36 during assembly. Often, it is desired that the front panel have an aesthetic curvature because collectively it forms part of the outer appearance of the RTA furniture unit 10. In the version, the top edge 72 is curved at a first side.

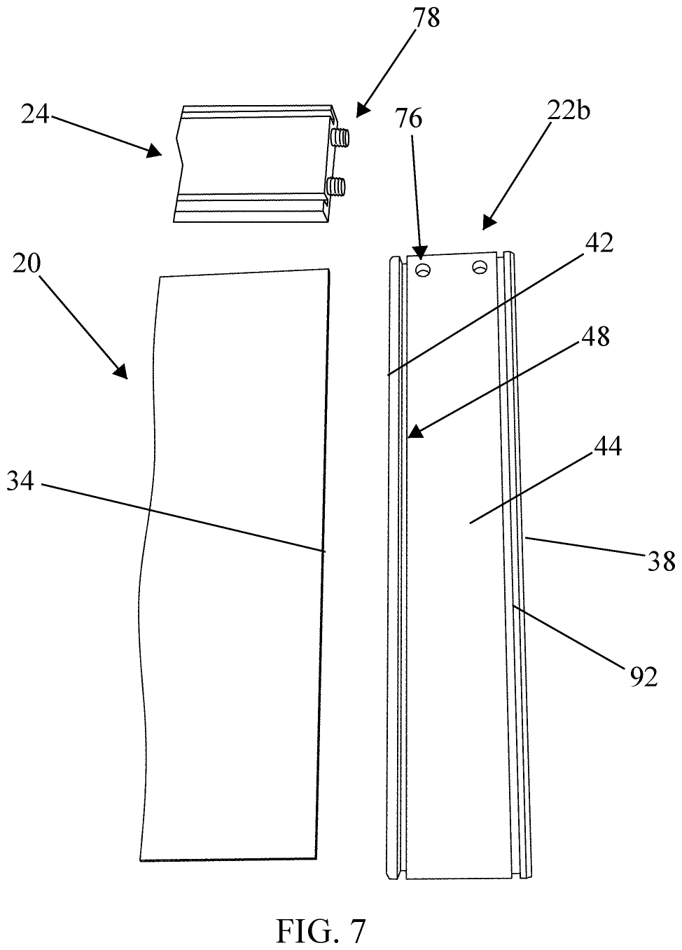

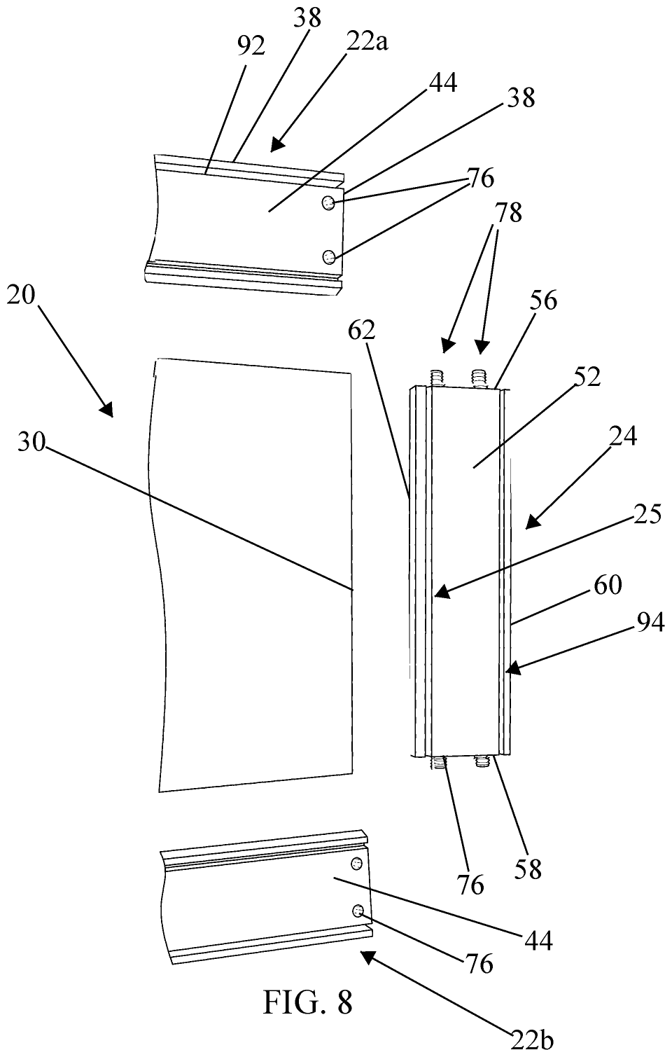

As best illustrated by FIG. 7-FIG. 12, generally, each of the drawer assembly 14 bottom panel 20, first and second side panels 22a, 22b, the front panel 26, and the back panel 24 are affixed together by a pattern of a plurality of dowel holes 76 fitted with a plurality of semi-permanent dowel connectors 78 near the ends of each panel of the drawer assembly 14. The dowel connectors 78 are designed to easily and quickly connect coupled panel ends generally at right angles of the drawer assembly 14.

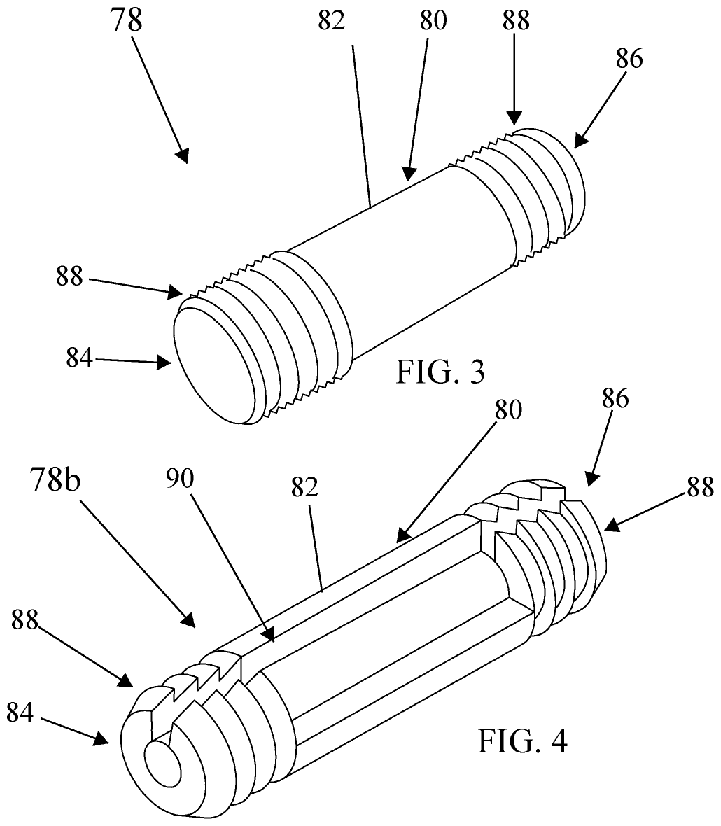

Referring to FIG. 3 and FIG. 4, in a version, each of the dowel connectors 78 consists of an elongated body 80 having a midsection 82, opposing sides 84, 86, and a plurality of longitudinally aligned truncated cone sections 88 extending form the midsection 82 being tapered towards the opposite side of the body 84, 86. Each dowel connector 78 adapted and configured to be press fit within the adjacently aligned pre-drilled dowel holes 76 between connected adjacent drawer assembly 14 panels.

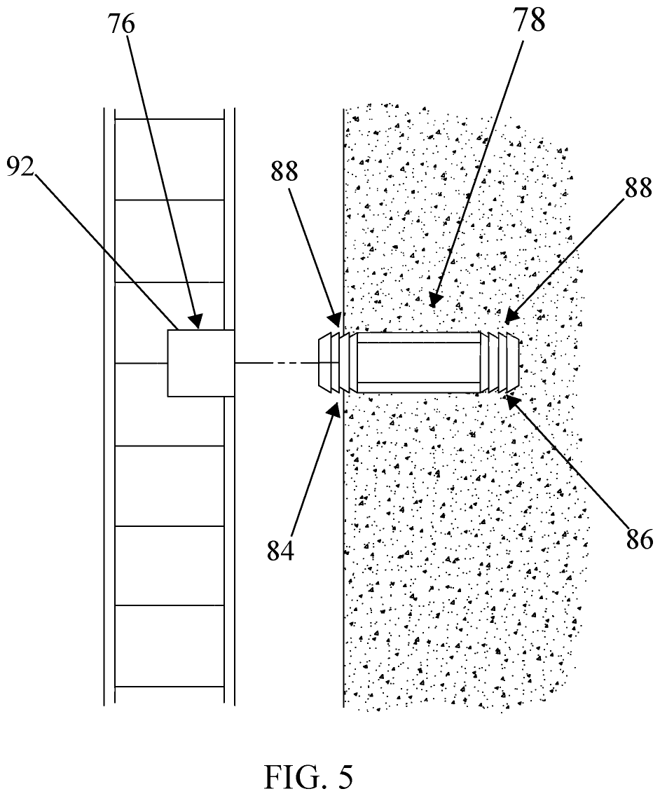

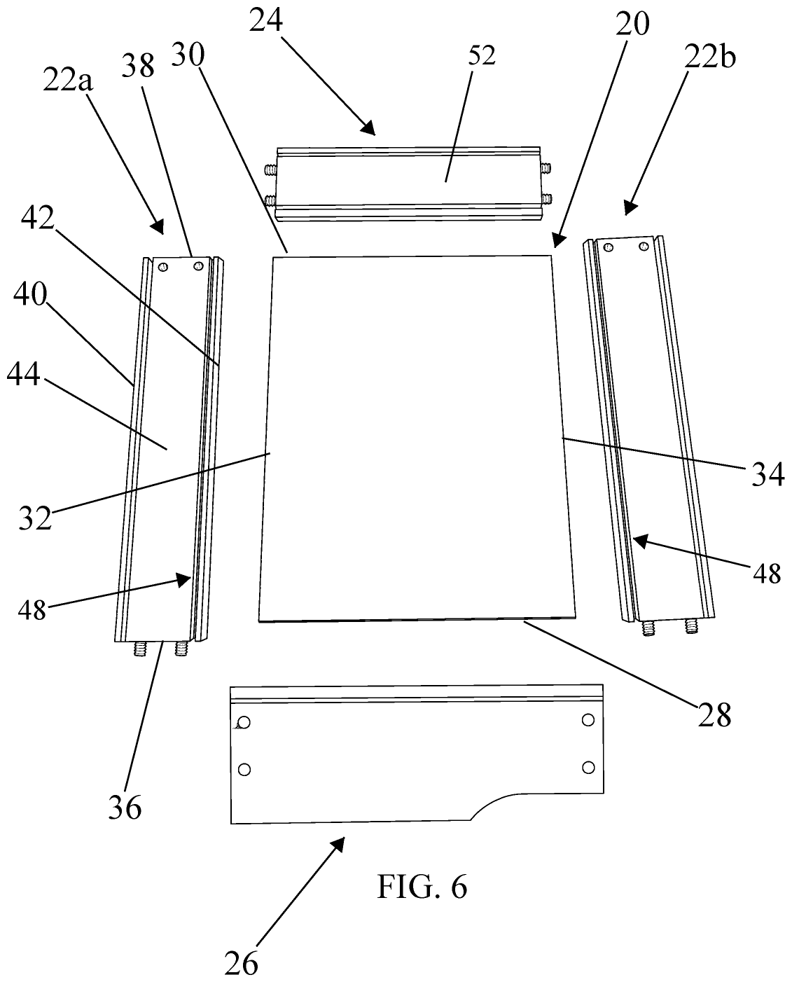

In particular reference to FIG. 5, each of the truncated cone sections 88 at opposing sides 84, 86 of each dowel connectors 78 provides a general cylindrical profile having a diameter substantially equal or greater than the diameter of the pre-drilled dowel hole 76 within which the nylon dowel connector 78 is inserted at each opposing end 84, 86, thereby providing the friction type press fit which is semi-permanent. With reference to the version illustrated in FIG. 4, the dowel connector 78 may further provide a longitudinal slot 90 which extends the length of the dowel connector 78. The longitudinal slot 90 generally permits the truncated cone sections 88 to be inwardly compressed as the dowel connector 78 is inserted into the dowel holes 76 with the resilience of the dowel connector 78 material biasing the truncated cones sections 88 outwardly into a locking engagement with the inner wall surface 92 of the dowel hole 76 (FIG. 5).

Preferably, the dowel connectors 78 are manufactured from wood, plastic, and/or composite materials. Ideally, the dowel connectors 78 are made of an injection mold plastic such as nylon and may be pre-inserted into select drawer panels during manufacture in order to expedite the assembly of the RTA unit.

With reference now to FIG. 7-FIG. 10, in a first version, the drawer back panel 24 first and second side edges 56, 58 is affixed to the interior surface 44 of each respective first and second side panels 22a, 22b and the drawer front panel 26 interior surface 64 is affixed to the front edge 36 of each of the respective first and second drawer side panels 22a, 22b collectively forming a robust rectangular drawer assembly.

Referring now to FIG. 8, the drawer back panel 24 is generally a rectangular configuration having opposing interchangeable first and second side edges 56, 58, each providing two or more outwardly exposed dowel holes 76 configured for receipt and coupling of two or more dowel connectors 78. In the illustrated version, the drawer back panel 24 is mounted between and detachably connected to each of the interchangeable drawer first and second side panels 22a, 22b interior surfaces near the first and second side panel 22 rear edges 38 by way of aligned reciprocal dowel holes 76 and respective shared dowel connectors 78.

In the version, the drawer back panel 24 first and second side edges 56, 58 are connected by at least two vertically aligned dowel connectors 78 to the first and second side panel 22a, 22b interior surfaces 44 near the respective rear edges 38 forming a right-angle corner between the panels. In detail, the drawer back panel 24 first and second side edges 56, 58 form at least two outwardly exposed vertically aligned dowel holes 76 and the first and second side panel 22a, 22b interior surface 44 near the rear edge 38 forms two reciprocal inwardly exposed vertically aligned dowel holes 76 for receipt of a the shared dowel connector 78 connecting the drawer back panel 24 with the drawer first and second side panels 22a, 22b.

In a version, each of the first and second side panel 22a, 22b front edge 36 is connected by at least two vertically aligned dowel connectors 78 to the front panel 26 interior surface 64 near each respective first and second side edges 68, 70 forming right-angle corners between the panels. In detail, each of the drawer first and second side panel 22a, 22b front edge 28 forms at least two forward exposed vertically aligned dowel holes 76 for receipt of one more dowel connectors 78. Reciprocally, the drawer front panel 26 interior surface 64 near each respective first and second side edges 68, 70 define at least two aligned dowel holes 78 for receipt of aligned dowel connectors 78, thereby connecting the drawer front panel 26 with the first and second drawer side panels 22a, 22b.

In other versions of the invention, the drawer assembly 14 panel connections may be rearranged. Namely, each of the first and second side panel 22a, 22b rear edge 38 may be connected by at least two vertically aligned dowel connectors 78 to the drawer back panel 24 interior surface 52 and proximate the respective back panel 24 first and second side edge 56, 58. Moreover, the front panel 26 first and second side edges 68, 70 may be connected by at least two vertically aligned dowel connectors 78 to the respective drawer first and second side panel 22a, 22b interior surfaces 44 and proximate the respective first and second side panels 22a, 22b front edges 36.

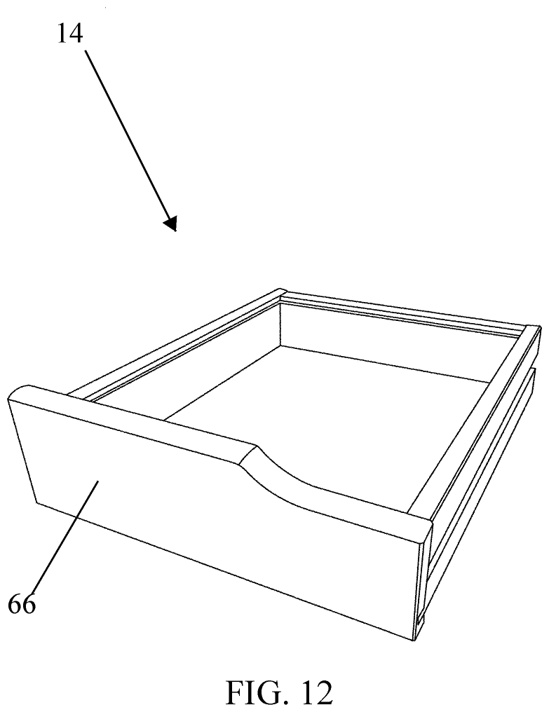

Now with reference to FIG. 7, FIG. 10, and FIG. 11, in the version, the drawer assembly 14 first and second side panels 22a, 22b may further form a second longitudinal slot 92 positioned near the respective top edge 38 or opposing longitudinal edge operably shaped for receipt of the respective bottom panel 20 side edge 32, 34, thereby permitting the first and second side panels 22a, 22b to be interchangeable during assembly. In further terms, each of the interchangeable drawer first and second side panels 22a, 22b is designed such that they may be universally interchanged with the other—meaning each drawer 14 side panel 22a, 22b will function as either the left-side panel or the right-side panel. Because the left and right-side panels can be reciprocally interchanged, the likelihood of improper assembly is substantially reduced, particularly in view of the semi-permanent connection established by the plurality of dowel connectors 78. For example, the first side panel 22a can be utilized in place of the second side panel 22b and vice versa. Thus, allowing the consumer to assemble without the possibility of incorrectly assembling a side panel in the wrong position with a semi-permanent dowel connector 78.

In a version, the drawer back panel 24 interior surface 52 may further form a second longitudinal slot 94 parallel to the back panel 24 first longitudinal slot 25 and positioned proximate the top edge 60 operably shaped for receipt of the respective bottom panel rear edge 30. The parallel longitudinal slots 25, 94 positioned on the interior surface 52 allow the drawer back panel 24 to be inverted (flipped) and still align with the drawer bottom panel 20 rear edge 30 during assembly. Thus, reducing the likelihood of improper assembly of the drawer back panel 24 with the drawer bottom panel 20 throughout assembly.

A certain method of assembly of the drawer assembly 14 generally comprises the steps of: (a) positioning the first and second side panels 22a, 22b in a parallel configuration (see FIG. 10); (b) connecting the drawer back panel 24 with the first and second side panels 22a, 22b with one or more dowel connectors 78; (c) seating the bottom panel 20 rear edge 30, first and second side edges 32, 34 within respective first and second side panel 22a, 22b longitudinal slots 48 and the back panel 24 longitudinal slot 25; and (d) connecting the front panel 26 with the first and second side panels 22a, 22b with one or more nylon dowel connectors 78.

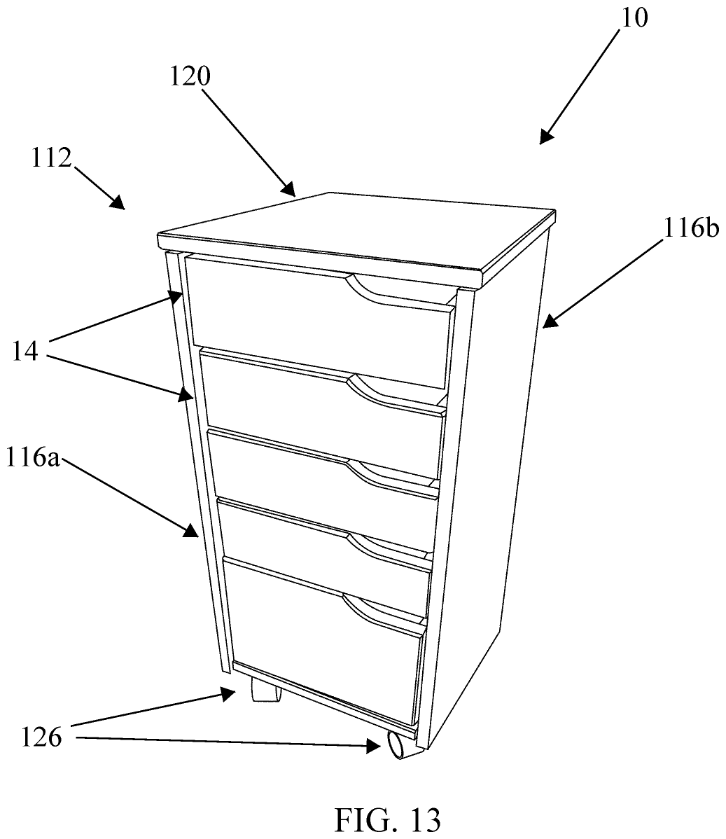

FIG. 13 illustrates a version of the fully assembled RTA furniture unit 10 providing the framework assembly 112 and the plurality of drawer assemblies 14 and is operably assembled by way of a plurality of dowel connectors 78 as described above. In the version, the framework assembly 112 forms an upright container for slidably supporting the plurality of drawer assemblies 14. In the version, the RTA furniture unit 10 is a roll cart which is supported by and moveable upon one or more castors 126 rotatably attached is the bottom of the framework 114.

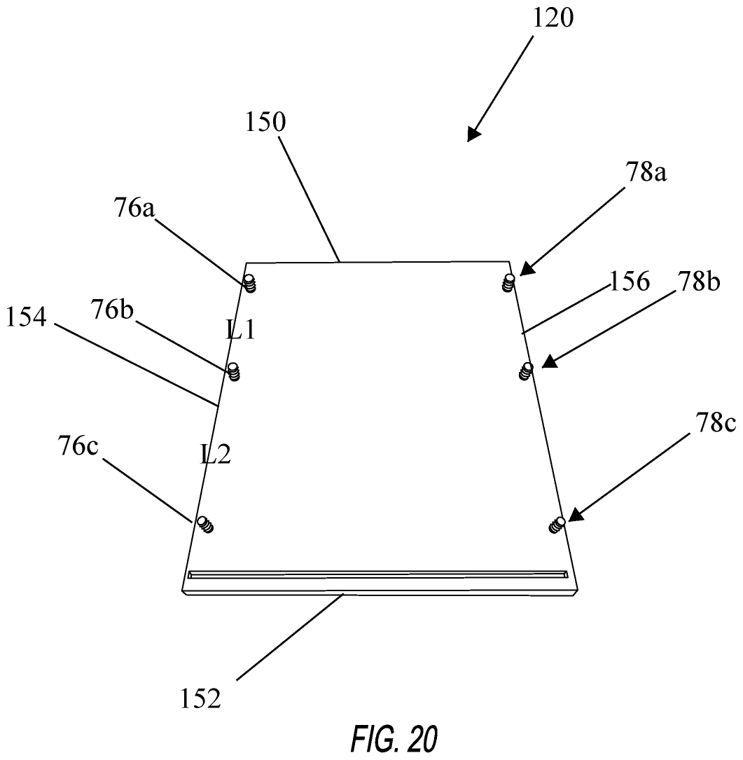

Generally referring to FIG. 13-FIG. 22, the framework assembly 112 generally comprises one or more castor assemblies 114, a first and second side panels 116a, 116b, a back panel 118, and a top panel 120 which may be provided in a kit to the consumer for assembly or be preassembled forming a moveable set of drawers.

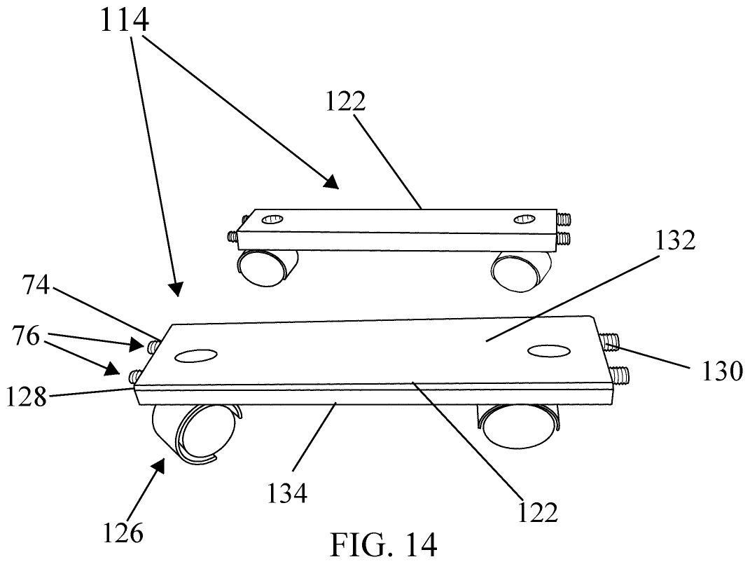

FIG. 14 is an illustrative perspective view of the one or more castor support assemblies 114. In the version, each castor support assembly 114 generally comprises a support member 122, castor inserts 124, and corresponding castors 126. As illustrated, each support member 122 comprises a rectangular body having opposing first and second side edges 128, 130, top surface 132, and bottom surface 134 supporting the castor inserts 124 downward towards the ground surface. Each of the first and second side edges 128, 130 providing at least two dowel holes 74 for providing receipt and seating of two or more dowel connectors 76 as described above. Each castor 126 is inserted and coupled with the requisite castor insert 124 in order to provide a rolling support to the roll cart 10.

Referring to FIG. 15-FIG. 18, each of the first and second side panels 116a, 116b generally have a front edge 136, a rear edge 138, a top edge 140, a bottom edge 142 forming a rectangular board having an interior surface 144 and an exterior surface 146. Each of the side panels 116a, 116b is generally mounted parallel and upright relative to the other side panel and the forward and rear castor support assemblies 114. A plurality of opposing drawer runners 148 are operably positioned on the interior surfaces 144 in order to provide support for each of the drawer assemblies 14.

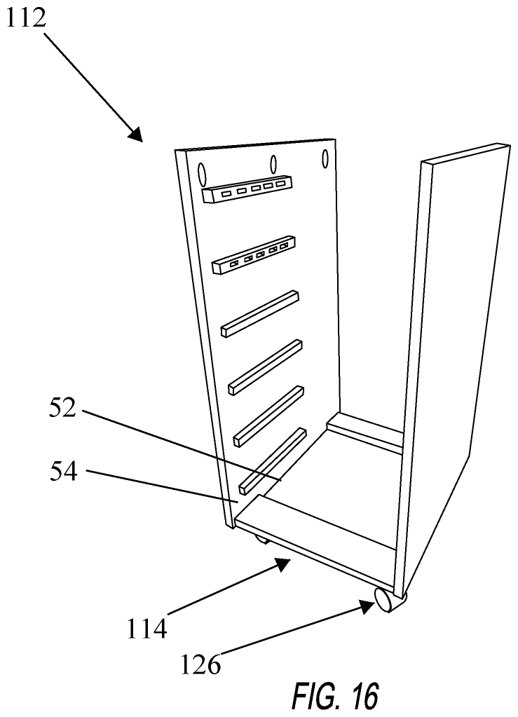

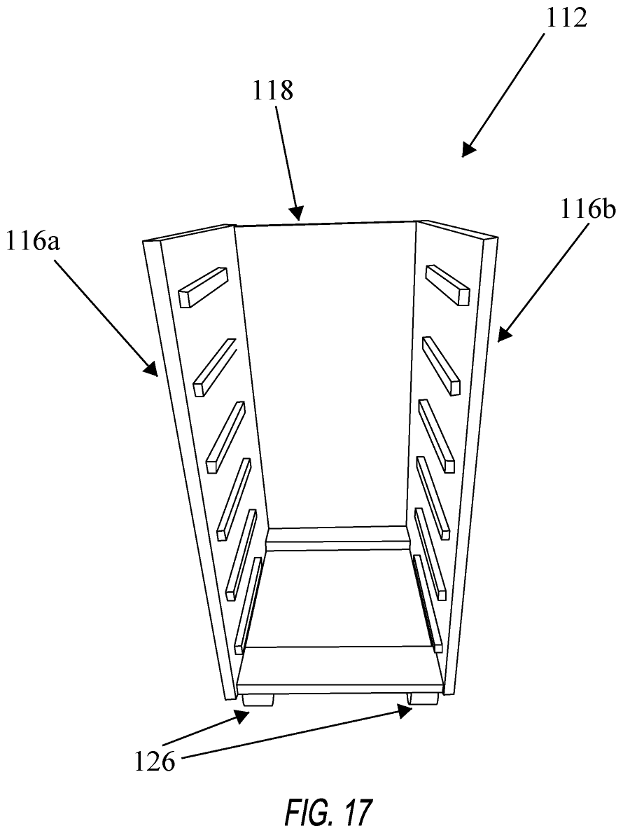

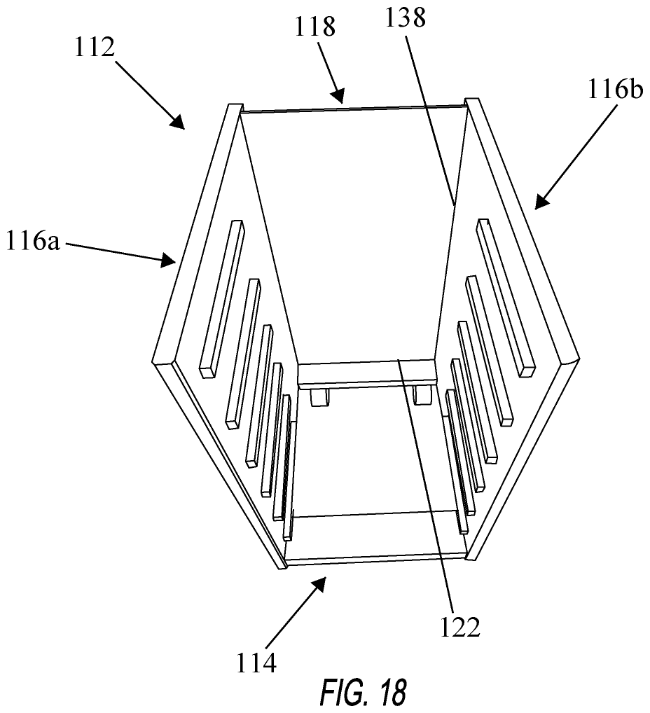

Generally, as illustrated by FIG. 16, each of the castor support assemblies 114 connects to the first and second side panels 116a, 116b interior surfaces 54 proximate to the bottom edges 52 (See FIG. 15 and FIG. 16) using at least one dowel connector 78. The castor support assemblies 114 combine to form a platform for supporting the castors 126 and the overall framework 112 as shown in FIG. 17. In the illustrated version, two dowel connectors 78 are utilized at each side 128, 130 of each castor support member 122—connecting reciprocal dowel holes 76 between the castor support member 122 and the requisite side panel 116a, 116b.

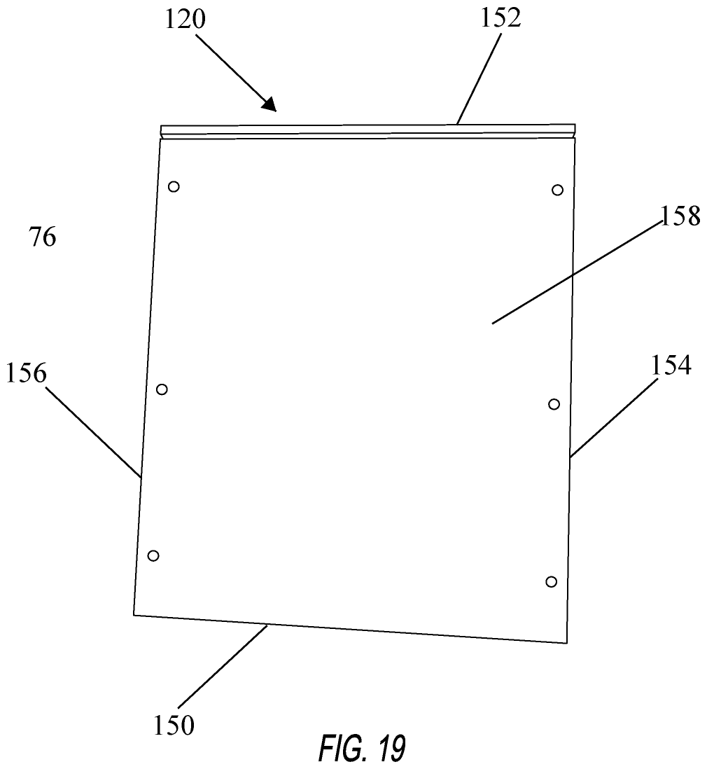

With reference to FIG. 19-FIG. 22, the top panel 120 generally consists of a rectangular board having a front edge 150, a rear edge 152, opposing first and second side edges 154, 156, a bottom surface 158, and a top surface 160. The top panel 120 is operably configured to be detachably connected to the top edge 140 of each of the mounted first and second side panels 116a, 116b. In the illustrated version, the bottom surface 158 comprises a plurality of dowel hole 76 near the perimeter—configured to align and detachably connect by way of dowel connectors 78 to the top edge 140 of each of the first and second side panels 116a, 116b.

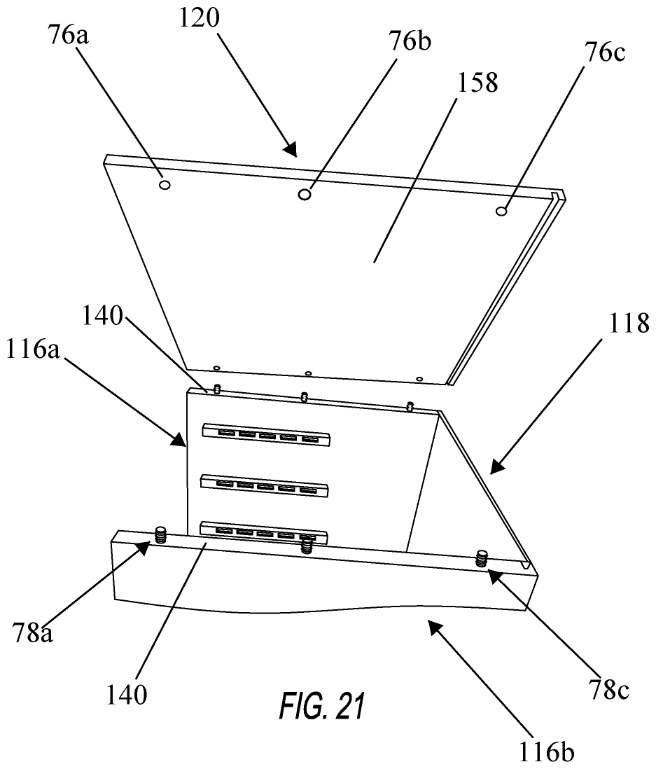

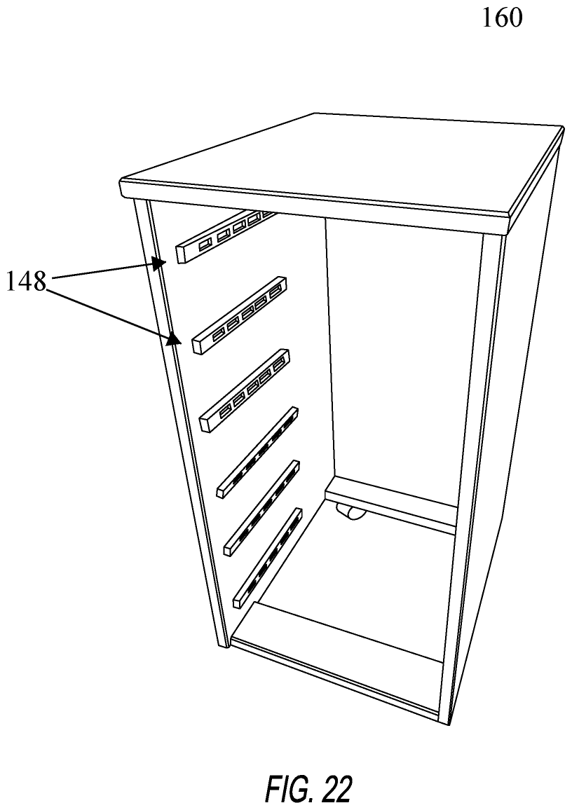

In a certain version, the top panel 120 comprises at least three predrilled dowel holes 76a, 76b, and 76c aligned downward along each respective opposing first and second side edges 154, 156. Uniquely, the distance between each predrilled hole 76 in series is unequal. For example, the in illustrated version, the distance L1 (FIG. 19—FIG. 21) between hole 76a and hole 76b does not equal the distance L2 between hole 76b and 76c. For example, in the version, hole 76a and 76c are symmetrically placed at each corner of the top panel 120 and the hole 76b is offset along the line that connects holes 76a and 76c, thereby providing an unequal distance between each respective hole 76 in series.

In further detail, the top edge 140 of each of the first and second panels 116a, 116b reciprocally boast predrilled offset dowel holes 76 which align with the offset dowel holes 76 of the bottom surface 158 of the top panel 120 and are connected by way of at least six dowel connectors 78. Uniquely, the offset nature of the reciprocally predrilled dowel holes 76 force the correct orientation of the top panel 120 during assembly of the RTA furniture unit 10. For example, if the top panel 120 orientation was mistakenly reversed, the reciprocal center dowel holes 76b and dowel connector 78b would not align and therefore indicate improper orientation to the assembler. Because the dowel connectors 78 are semi-permanent, it is important that they are set in the correct reciprocal hole 76; otherwise, removal of a dowel connector 78 may cause unwanted damage. Thus, the offset distance between the dowel holes 76 force the assembler to assemble the top panel 120 in the correct orientation.

As best illustrated by FIG. 18, the framework assembly back panel 118 is generally a rectangular sheet and is configured to attach by way of nails along the rear outer perimeter of the framework assembly 112 formed by the rear edges 138 of the first and second side panels 116a, 116b as well as the rear edge 152 of the top panel 120 and the rear edge of the support member 122 of the rear castor support assembly 114.

A certain method of assembly of the framework assembly 14 may generally comprises the steps of: (a) positioning the forward and rearward castor support assemblies 114 in parallel (See FIG. 14); (b) attach the first and second side panels 116a, 116b in an upright parallel configuration to the forward and rearward castor support assemblies 114 utilizing one or more dowel connectors 78 (see FIG. 15 and FIG. 16); (c) connecting the framework top panel 120 with the top edge 140 of each of the first and second side panels 116a, 116b with one or more dowel connectors 78; (d) seating the framework back panel 118 via nails to the rear outer perimeter of the framework assembly 112.

The present invention can be made in any manner and of any material chosen with sound engineering judgment. Preferably, the RTA roll cart 10 is constructed of wood, plastic or other materials that are strong, lightweight, long-lasting, economical, and ergonomic.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure.

What is claimed is:

1. A ready-to-assemble drawer assembly comprising:
a bottom panel having a front edge, a rear edge, and first and second side edges;
a first and second side panels mounted parallel to each other, each side panel having an interior surface and an exterior surface defined between a front edge, a rear edge, a top edge and a bottom edge; the interior surface forming at least one longitudinal slot positioned proximate to the bottom edge operably shaped for receipt of the respective bottom panel first and second side edge;
a back panel having an interior surface, and first and second side edges;
at least one nylon dowel connector connecting each of the rear edges of the first and second side panels with the respective back panel first and second side edges;
a front panel having an interior surface, and first and second side edges; and
at least one nylon dowel connector connecting each of the front edges of the first and second side panels with the respective front panel first and second side edges;
wherein each nylon dowel connector comprises an elongated body having a midsection, opposing sides, and a plurality of longitudinally aligned truncated cone sections extending from the midsection being tapered towards the opposite side of the body.

2. The ready-to-assemble drawer assembly of claim 1, wherein the back panel first and second side edges are connected by at least two vertically aligned dowel connectors to the first and second side panel interior surfaces near the respective first and second side rear edges.

3. The ready-to-assemble drawer assembly of claim 2, wherein each side panel front edge is connected by at least two vertically aligned dowel connectors to the front panel interior surface near each respective front panel first and second side edges.

4. The ready-to-assemble drawer assembly of claim 3, wherein each of the first and second side panels interior surfaces further form a second longitudinal slot positioned proximate to the top edge operably shaped for receipt of the respective bottom panel side edge, thereby permitting the first and second side panels to be interchangeable.

5. The ready-to-assemble drawer assembly of claim 1, wherein each of the first and second side panels interior surfaces further form a second longitudinal slot positioned proximate to the top edge operably shaped for receipt of the respective bottom panel side edge, thereby permitting the first and second side panels to be interchangeable.

6. The ready-to-assemble drawer assembly of claim 5, wherein the back panel interior surface further forms a second longitudinal slot positioned proximate to the back panel top edge operably shaped for receipt of the respective bottom panel rear edge, thereby permitting the first and second side panels to be interchangeable.

7. The ready-to-assemble drawer assembly of claim 1, wherein each side panel rear edge is connected by at least two vertically aligned dowel connectors to the back panel interior surface and proximate the respective back panel first and second side edge.

8. The ready-to-assemble drawer assembly of claim 7, wherein the front panel first and second side edges are connected by at least two vertically aligned dowel connectors to the respective first and second side panel interior surfaces and proximate the respective first and second side panels front edges.

9. The ready-to-assemble drawer assembly of claim 8, wherein each of the first and second side panels interior surfaces further form a second longitudinal slot positioned proximate to the top edge operably shaped for receipt of the respective bottom panel side edge, thereby permitting the first and second side panels to be interchangeable.

10. The ready-to-assemble drawer assembly of claim 1, wherein each nylon dowel connector further comprises a longitudinal slot extending length of the body permitting the truncated cone sections to be inwardly compressed.

11. The ready-to-assemble drawer assembly of claim 1, wherein each side panel exterior surface forming a longitudinal groove operably configured to receive a respective drawer runner.

12. A kit for assembling a drawer, the kit comprising in combination:
a bottom panel having a front edge, a rear edge, and first and second side edges;
a first and second side panels, each side panel having an interior surface and an exterior surface defined between a front edge, a rear edge, a top edge and a bottom edge; the interior surface forming at least one longitudinal slot positioned proximate to the bottom edge;
a back panel having an interior surface, first and second side edges;
a front panel having an interior surface, and first and second side edges;
a plurality of nylon dowel connectors for connecting the front panel, back panel, and first and second side panels, each nylon dowel connector comprises an elongated body having a midsection, opposing sides, and a plurality of longitudinally aligned truncated cone sections extending from the midsection being tapered towards the opposite side of the body.

13. The kit for assembling a drawer of claim 12, wherein the back panel first and second side edges define at least two vertically aligned dowel holes for receipt of one or more nylon dowel connectors and the first and second side panel interior surfaces near the respective rear edges define at least two reciprocal vertically aligned dowel holes for receipt of one or more nylon dowel connectors.

14. The kit for assembling a drawer of claim 13, wherein each side panel front edge forms at least two vertically aligned dowel holes for receipt of one more nylon dowel connectors and the front panel interior surface near each respective first and second side edges define at least two reciprocal vertically aligned dowel holes for receipt of one more nylon dowel connectors.

15. The kit for assembling a drawer of claim 13, wherein each of the first and second side panels interior surfaces further form a second longitudinal slot positioned proximate to the top edge, thereby permitting the first and second side panels to be interchangeable.

16. The kit for assembling a drawer of claim 12, wherein each of the first and second side panels interior surfaces further form a second longitudinal slot positioned proximate to the top edge, thereby permitting the first and second side panels to be interchangeable.

17. The ready-to-assemble drawer assembly of claim 16, wherein the back panel interior surface further forms a second longitudinal slot positioned proximate to the back panel top edge operably shaped for receipt of the respective bottom panel rear edge, thereby permitting the first and second side panels to be interchangeable.

18. The kit for assembling a drawer of claim 12, wherein each side panel rear edge forms at least two vertically aligned dowel holes for receipt of one or more nylon dowel connectors and the back panel interior surface and proximate the respective back panel first and second side edge forms at least two reciprocal vertically aligned dowel holes for receipt of one or more nylon dowel connectors.

19. The kit for assembling a drawer of claim 18, wherein the front panel first and second side edges form at least two vertically aligned dowel holes for receipt of one or more nylon dowel connectors and the first and second side panel interior surfaces proximate the respective first and second side panels front edges forms at least two reciprocal vertically aligned dowel holes for receipt of one or more nylon dowel connectors.

20. The kit for assembling a drawer of claim 18, wherein each of the first and second side panels interior surfaces further form a second longitudinal slot positioned proximate to the top edge operably shaped for receipt of the respective bottom panel side edge, thereby permitting the first and second side panels to be interchangeable.

21. The kit for assembling a drawer of claim 12, wherein each nylon dowel connector further comprises a longitudinal slot extending length of the body permitting the truncated cone sections to be inwardly compressed.

22. The kit for assembling a drawer of claim 12, wherein each side panel exterior surface forming a longitudinal groove operably configured to receive a respective drawer runner.

23. A method of assembling a drawer from a kit comprising in combination:
a bottom panel having a front edge, a rear edge, and first and second side edges;
a first and second side panels, each side panel having an interior surface and an exterior surface defined between a front edge, a rear edge, a top edge and a bottom edge; the interior surface forming at least one longitudinal slot positioned proximate to the bottom edge;
a back panel having an interior surface, first and second side edges;
a front panel having an interior surface, and first and second side edges;
a plurality of nylon dowel connectors for connecting the front panel, back panel, and first and second side panels, each nylon dowel connector comprises an elongated body having a midsection, opposing sides, and a plurality of longitudinally aligned truncated cone sections extending from the midsection being tapered towards the opposite side of the body;
the method comprising the steps of:
positioning the first and second side panels in a parallel configuration;
connecting the back panel with the first and second side panels with one or more dowel connectors
seating the bottom panel rear edge, first and second side edges within respective first and second side panel longitudinal slots and the back panel longitudinal slot; and
connecting the front panel with the first and second side panels with one or more nylon dowel connectors.
